(19) United States
(12) Patent Application Publication
(10) Pub. No.: US 2026/0229710 A1
(43) Pub. Date: Aug. 6, 2026

(54) ELECTRODE ASSEMBLY AND SECONDARY BATTERY INCLUDING THE ELECTRODE ASSEMBLY

(71) Applicant: SAMSUNG SDI CO., LTD., Yongin-si (KR)

(72) Inventors: Soong Ji BOO, Yongin-si (KR); Byoung Hwi LIM, Yongin-si (KR); Hyun Ho CHO, Yongin-si (KR)

(21) Appl. No.: 19/284,981

(22) Filed: Jul. 30, 2025

(30) Foreign Application Priority Data
Feb. 3, 2025 (KR) 10-2025-0012966

(51) Int. Cl. H01M 50/477; B60L 50/64; H01M 10/0587; H01M 50/107; H01M 50/152; H01M 50/186; H01M 50/342; H01M 50/474; H01M 50/586; H01M 50/595

(52) U.S. Cl. CPC H01M 50/477; H01M 10/0587; H01M 50/107; H01M 50/152; H01M 50/186; H01M 50/3425; H01M 50/474; H01M 50/586; H01M 50/595; B60L 50/64; H01M 2220/20

(57) ABSTRACT

Disclosed are an electrode assembly and a secondary battery including the same. The electrode assembly includes a first electrode plate having a first substrate and a first active material layer, a second electrode plate having a second substrate and a second active material layer, and a separator interposed between the first electrode plate and the second electrode plate. The first electrode plate, the second electrode plate, and the separator are stacked and wound. The separator may include an upper separator region extending farther from a winding trailing edge of each of the first electrode plate and the second electrode plate to wrap around an upper outermost side of the electrode assembly and a lower separator region extending farther from the winding trailing edge of each of the first electrode plate and the second electrode plate to wrap around a lower outermost side of the electrode assembly.

### CROSS-REFERENCE TO THE RELATED APPLICATION

The present application claims priority to and the benefit of Korean Patent Application No. 10-2025-0012966, filed on Feb. 3, 2025, in the Korean Intellectual Property Office, the entire disclosure of which is incorporated herein by reference.

### BACKGROUND

### 1. Field

Embodiments of the present disclosure relate to an electrode assembly and a secondary battery including the same.

### 2. Description of the Related Art

Unlike a primary battery that cannot be charged, a secondary battery is a rechargeable and dischargeable battery. A low-capacity secondary battery may be used for various portable small-sized electronic devices, such as a smartphone, a feature phone, a notebook computer, a digital camera, or a camcorder, and a high-capacity secondary battery is widely used as a power source for motor drives, such as those in hybrid vehicles or electric vehicles. The secondary battery includes an electrode assembly consisting of a positive electrode and a negative electrode, a case accommodating the same, and electrode terminals connected to the electrode assembly.

The above information disclosed in this Background section is only for enhancement of understanding of the background of the invention and therefore it may contain information that does not constitute prior art.

### SUMMARY

Embodiments of the present disclosure provide a composite finishing structure capable of solving the problem of cracks occurring at a winding trailing edge portion of an electrode assembly and the problem of nickel band formation caused by electrolyte accumulation.

However, the technical problems to be achieved in the embodiment of the disclosure are not limited to the technical problems mentioned above, and other technical problems not mentioned herein will be clearly understood from the following description by those skilled in the art to which the disclosure belongs.

An exemplary electrode assembly according to an embodiment of the present disclosure to accomplish the above object can include a first electrode plate having a first substrate and a first active material layer, a second electrode plate having a second substrate and a second active material layer, and a separator interposed between the first electrode plate and the second electrode plate. The first electrode plate, the second electrode plate, and the separator are stacked and wound. The separator may include an upper separator region extending beyond a winding trailing edge of each of the first electrode plate and the second electrode plate, the upper separator region configured to wrap around an upper outermost side of the electrode assembly and a lower separator region extending beyond the winding trailing edge of each of the first electrode plate and the second electrode plate, the lower separator region configured to wrap around a lower outermost side of the electrode assembly.

In some examples, the first substrate may be exposed so as to be in electrical contact with the case through the upper separator region and the lower separator region.

In some examples, the first substrate and the separator may be installed so as to wrap the outermost side of the electrode assembly.

In some examples, the separator may include an exposed region provided between the upper separator region and the lower separator region, and the first substrate may be in electrical contact with the case through the exposed region.

In some examples, the upper separator region and the lower separator region may be exposed to the outside (i.e., uncovered) while wrapping around an outermost side of the electrode assembly at least one turn, the outermost side including the upper outermost side and the lower outermost side.

In some examples, the upper separator region may be end, moving farther away from the winding trailing edge of each of the first electrode plate and the second electrode plate, with an upper finishing tape, and the lower separator region may end, moving farther away from the winding trailing edge of each of the first electrode plate and the second electrode plate, with a lower finishing tape.

An exemplary secondary battery according to an embodiment of the present disclosure to accomplish the above object includes an electrode assembly configured such that a first electrode plate having a first substrate and a first active material layer, a separator, and a second electrode plate having a second substrate and a second active material layer. The first electrode plate, the separator, and the second electrode plate are stacked and wound, the separator located between the first electrode plate and the second electrode plate. The exemplary secondary battery can further include a case configured to receive the electrode assembly, and a cap assembly configured to seal the case. The separator includes an upper separator region extending beyond a winding trailing edge of each of the first electrode plate and the second electrode plate, the upper separator region configured to wrap around an upper outermost side of the electrode assembly, and a lower separator region extending beyond the winding trailing edge of each of the first electrode plate and the second electrode plate, the lower separator region configured to wrap around a lower outermost side of the electrode assembly. The first substrate may be in electrical contact with the case in an exposed area between the upper separator region and the lower separator region.

In some examples, the separator may include the exposed region provided between the upper separator region and the lower separator region. In some examples, the first substrate may be in electrical contact with the case through the exposed region.

In some examples, the upper separator region and the lower separator region may be uncovered (i.e., exposed to the outside) while wrapping the outermost side of the electrode assembly for at least one turn, the outermost side including the uppermost side and the lower outermost side.

In some examples, the first substrate may be uncovered (i.e., exposed to the outside) while wrapping the outermost side of the electrode assembly at least one turn, the outermost side including the uppermost side and the lower outermost side.

In some examples, each of the vertical width of the upper separator region and the vertical width of the lower separator region is between 5% to 40% of the total vertical width of the electrode assembly.

In some examples, the vertical width of an exposed region of the first substrate may be between 60% to 95% of the total width of the electrode assembly.

In some examples, the upper separator region may end, moving farther away from the winding trailing edge of each of the first electrode plate and the second electrode plate, with an upper finishing tape, and the lower separator region may end, moving farther away from the winding trailing edge of each of the first electrode plate and the second electrode plate, with a lower finishing tape.

In some examples, the vertical width of the upper finishing tape may be less than the vertical width of the upper separator region, and the vertical width of the lower finishing tape may be less than the vertical width of the lower separator region.

In some examples, the upper finishing tape may couple to an upper region of the first substrate through the upper separator region, and the lower finishing tape may couple to a lower region of the first substrate through the lower separator region.

In some examples, the first electrode plate may be electrically connected to the case via a first electrode tab, and the second electrode plate may be electrically connected to the cap assembly via a second electrode tab.

In some examples, the cap assembly may include a upper cap, a safety vent coupled to the upper cap, a lower cap which is coupled to the safety vent and to which the second electrode tab is electrically connected, and an insulating gasket interposed between the upper cap and the safety vent, the insulating gasket in contact with an interior of the case.

In some examples, the cap assembly may include a rivet terminal to which the second electrode tab is electrically connected, an insulating gasket coupled to the outside of the rivet terminal, and a cap plate coupled to the outside of the insulating gasket and coupled to the case.

In some examples, the cap assembly may include a cap plate configured to block a lower side of the case. In some examples, the secondary battery may include a rivet terminal coupled to an upper side of the case, wherein an insulating gasket is interposed between the upper side of the case and the rivet terminal.

In some examples, the first electrode plate may be electrically connected to the case via a first current collecting plate, and the second electrode plate may be electrically connected to the rivet terminal via a second current collecting plate.

In some examples, the cap plate may be coupled and fixed between (a) a beading portion of the case, the beading portion extending inwardly on the case, and (b) a crimping portion bent inwardly of the case, the crimping portion bending inwardly from the case.

### BRIEF DESCRIPTION OF THE DRAWINGS

The following drawings attached to this specification illustrate preferred embodiments of the present disclosure, and serve to further understand the technical idea of the present disclosure together with the detailed description of the present disclosure, and thus, the present disclosure should not be construed as being limited to the matters described in such drawings.

FIG. 1 is a perspective view showing an example of an electrode assembly according to an embodiment of the present disclosure;

FIG. 2 is a perspective view showing an example of the state in which an end of the electrode assembly according to the embodiment of the present disclosure is unfolded;

FIG. 3 is an exploded perspective view showing an example of the end of the electrode assembly according to the embodiment of the present disclosure;

FIG. 4 is an exploded front view showing an example of the end of the electrode assembly according to the embodiment of the present disclosure;

FIG. 5 is a perspective view of an example of a secondary battery according to an embodiment of the present disclosure;

FIG. 6 is a longitudinal sectional view of an example of a secondary battery according to the embodiment of the present disclosure;

FIG. 7 is an exploded perspective view of an example of a secondary battery according to the embodiment of the present disclosure;

FIG. 8 is a perspective view of an example of a secondary battery according to another embodiment of the present disclosure;

FIG. 9 is a longitudinal sectional view of an example of the secondary battery according to the other embodiment of the present disclosure;

FIG. 10 is a perspective view of an example of a secondary battery according to yet another embodiment of the present disclosure;

FIG. 11 is a longitudinal sectional view of an example of the secondary battery according to the yet another embodiment of the present disclosure;

FIG. 12 is a perspective view of an example of a secondary battery according to still yet another embodiment of the present disclosure;

FIG. 13 is a longitudinal sectional view of an example of the secondary battery according to the still yet another embodiment of the present disclosure;

FIGS. 14 and 15 are perspective views showing examples of a battery pack according to an embodiment of the present disclosure; and

FIGS. 16 and 17 are a perspective view and a side view, respectively, showing examples of a vehicle body and vehicle body parts according to an embodiment of the present disclosure.

### DETAILED DESCRIPTION OF EXEMPLARY EMBODIMENTS

Hereinafter, the present disclosure will be described in detail. Prior to giving the following detailed description of the present disclosure, it should be noted that the terms and words used in the specification and the claims should not be construed as being limited to ordinary meanings or dictionary definitions but should be construed in a sense and concept consistent with the technical idea of the present disclosure, on the basis that the inventor can properly define the concept of a term to describe the disclosure in the best way possible. Therefore, the embodiments described in the specification and the configurations described in the drawings are only the most preferred embodiments of the present disclosure, and do not represent all of the technical ideas of the present disclosure. It is to be understood that there may be various equivalents and variations in place of them at the time of filing the present application. In addition, as used herein, the terms “comprise or include” and/or “comprising or including,” when used in this specification, specify the presence of stated features, numbers, steps, operations, elements, and/or components, but do not preclude the presence or addition of one or more other features, numbers, steps, operations, elements, components, and/or groups thereof. In addition, when describing embodiments of the present disclosure, “can” and “may” may include “one or more embodiments of the present disclosure.”

In addition, for a better understanding of the invention, the attached drawings are not drawn to scale and the dimensions of some components may be exaggerated. In addition, the same reference numbers may be assigned to the same components in different embodiments.

A reference to two objects in comparison being the same means that they are substantially the same. Thus, the wording “substantially the same” may include cases where the same is considered to be a low level in the related art, for example, a deviation within 5%. In addition, when any of parameters is referred to as being uniform in a given region, it may mean that the parameter is uniform from an average perspective.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, unless otherwise defined, a first element, component, region, layer or section described below could be termed a second element, component, region, layer or section, without departing from the spirit and scope of the present disclosure.

Throughout the specification, each component may be singular or plural, unless the context clearly indicates otherwise.

The arrangement of an arbitrary component on the “upper portion (or lower portion)” or “upper (or lower) portion” of a component means that an arbitrary component is placed in contact with the upper (or lower) surface of the component. In addition, it may mean that other components may be interposed between the component and any component disposed on (or under) the component.

Also, it will be understood that when an element is referred to as being “connected to,” “coupled to,” or “linked to” another element, these elements can be directly connected or coupled to each other, another intervening element may be present therebetween, or the respective elements may be connected, coupled, or linked to each other through another elements.

Throughout the specification, the expression “A and/or B” means A, B, or A and B, unless otherwise defined. That is, as used herein, the term “and/or” includes any and all combinations of one or more of the associated listed items. The expression “C to D” means C or more and D or less, unless otherwise defined.

As used herein, the terms are for describing embodiments of the present disclosure and are not intended to limit the disclosure.

Hereinafter, an electrode assembly 120 according to an embodiment of the present disclosure and a secondary battery 100 including the same will be described in detail with reference to the accompanying drawings.

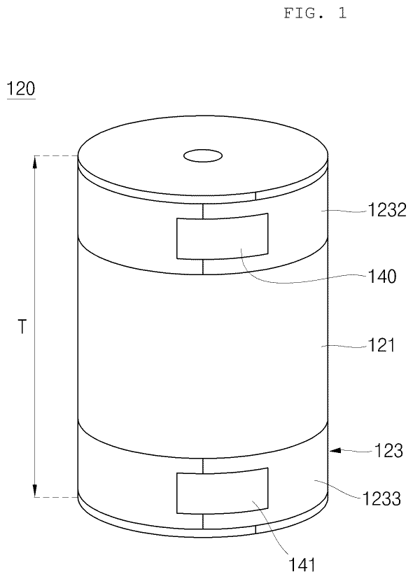

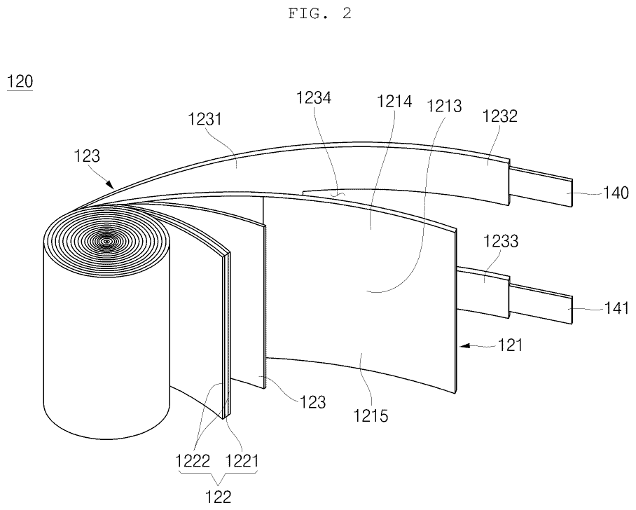

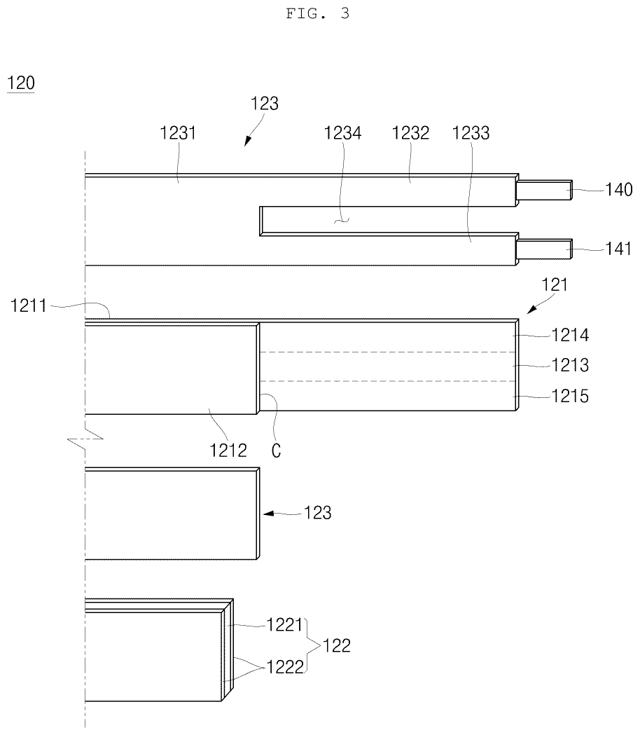

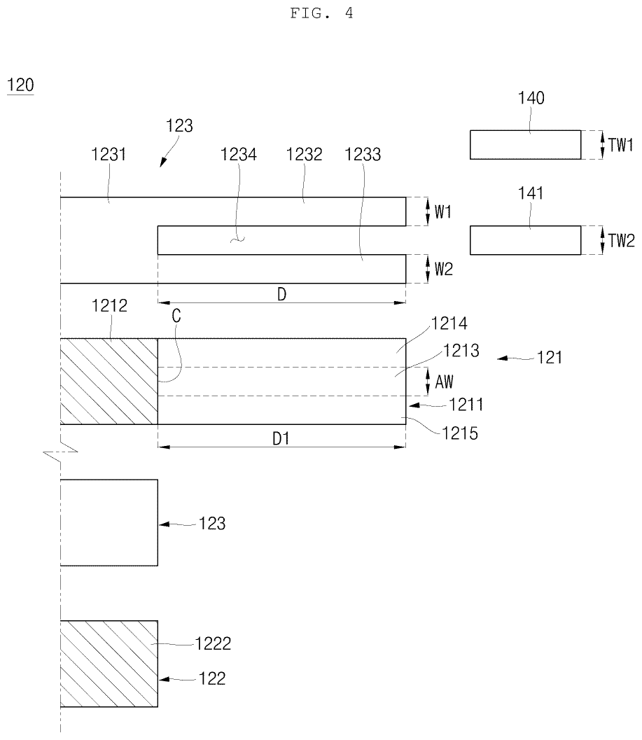

FIG. 1 is a perspective view showing an example of an electrode assembly 120 according to an embodiment of the present disclosure, FIG. 2 is a perspective view showing an example of the state in which an end of the electrode assembly 120 according to the embodiment of the present disclosure is unfolded, FIG. 3 is an exploded perspective view showing an example of the end of the electrode assembly 120 according to the embodiment of the present disclosure, and FIG. 4 is an exploded front view showing an example of the end of the electrode assembly 120 according to the embodiment of the present disclosure. As shown in FIGS. 1 to 4, the electrode assembly 120 according to the embodiment of the present disclosure may include a first electrode plate 121, a second electrode plate 122, and a separator 123. The electrode assembly 120 may further include an upper finishing tape 140 and a lower finishing tape 141.

The electrode assembly 120 according to the embodiment of the present disclosure may be provided in a cylindrical shape. In one or more embodiments, the outermost side of the electrode assembly 120 may be finished with the separator 123, the upper finishing tape 140, and the lower finishing tape 141, such that the electrode assembly 120 cannot be unwound after a winding process. In one or more embodiments, the electrode assembly 120 may include a core, which is an empty space, provided in the center thereof. In one or more embodiments, a first substrate 1211 may be exposed and/or may protrude upwardly of the electrode assembly 120, and a second substrate 1221 may be exposed and/or may protrude downwardly of the electrode assembly 120. The opposite configuration may also be possible. In one or more embodiments, any one of the first substrate 1211, the second substrate 1221, and the separator 123 may be wound around the outermost side of the electrode assembly 120. The wound electrode assembly 120 may include or be referred to as an electrode group, an electrode body, or a jelly-roll (as illustrated in FIG. 2).

In one or more embodiments, the first electrode plate 121 may include or be referred to as a negative electrode plate, and the first substrate 1211 may include or be referred to as a negative electrode substrate. The second electrode plate 122 may include or be referred to as a positive electrode plate, and the second substrate 1221 may include or be referred to as a positive electrode substrate. The opposite configuration may also be possible.

In the electrode assembly 120 according to the embodiment of the present disclosure, the first electrode plate 121, the second electrode plate 122, and the separator 123 may be stacked and wound, with the separator 123 between the first electrode plate 121 and the second electrode plate 122. The first substrate 1211 and the separator 123 may be installed so as to wrap around the outermost side of the electrode assembly 120.

The electrode assembly 120 may be formed in a cylindrical shape, and the separator 123 located at the outermost side of the electrode assembly 120 may prevent the accumulation of an electrolyte while serving as a cushion for the finishing parts. The separator 123 and the negative electrode substrate of the electrode assembly 120 may be disposed at the outermost side of the electrode assembly 120.

The separator 123 may be disposed at the outermost side of the electrode assembly 120 to provide a buffering function. Accordingly, the cushion effect of the separator 123 may alleviate cracks that occur in the parts of the upper finish tape 140 and the lower finish tape 141 in contact with the separator 123. The structural stability of a trailing edge portion may be secured through the cushion function of the separator 123, whereby it is possible to suppress the occurrence of cracks even at high cycle counts.

The phenomenon of electrolyte accumulation between the first substrate 1211, which is a negative electrode substrate located at the outermost side of the electrode assembly 120, and a case 110, a description of which will follow, may be minimized, whereby it is possible to prevent low voltage failure caused by the formation of a nickel band. To this end, the separator 123 may be designed to disperse the electrolyte properly and to prevent the electrolyte from being accumulated and isolated between the first substrate 1211 and the case 110.

The first electrode plate (e.g., the negative electrode plate) 121 (according to the embodiment of the present disclosure) may include a first substrate 1211 and a first active material layer 1212. As an example, the first substrate 1211 may be exposed to the outside (uncovered) while wrapping around the outermost side of the electrode assembly 120 at least one turn. In one or more embodiments, a first active material (e.g., a negative electrode active material including graphite or carbon) may be coated on the first substrate (e.g., a negative electrode substrate) 1211 to form the first active material layer (e.g., a negative electrode active material layer) 1212. The first substrate 1211 may include a copper (Cu) or nickel (Ni) foil.

The first active material layer 1212 may be coated up to a winding trailing edge C of the first electrode plate 121. The first substrate 1211 may extend beyond the winding trailing edge C and may be wound while wrapping around the outer side of the electrode assembly 120 at least one turn. The first substrate 1211 where the first active material layer 1212 is not coated may be divided into an exposed region 1213 that is in contact with the case 110 through the separator 123, and both an upper region 1214 and a lower region 1215 that are not in contact with the case 110 as the result of being covered by the separator 123. This structure may contribute to suppressing accumulation of the electrolyte on the outside of the electrode assembly 120 and enhancing the stability of the battery.

A winding trailing edge C according to an embodiment of the present disclosure may correspond to an outer end of the first active material layer 1212, which may be configured identically or similarly to an outer end of the second electrode plate 122. The separator 123 located between the first electrode plate 121 and the second electrode plate 122 may be wound up to the winding trailing edge C or may extend beyond the winding trailing edge C. In one or more embodiments, the winding trailing edge C may refer to the region where winding ends in the state in which the first active material layer 1212 and the second electrode plate 122 are stacked. That is, the winding trailing edge C may refer to the location where the complete stack (e.g., the first electrode plate 121 and/or the first active material layer 1212 is stacked over the separator 123 and the second electrode plate 122) ends because one or more pieces of the wound stack have run out of material, such that the multi-layer nature of the stack ends.

The first electrode plate 121 may include only the first substrate 1211 where the first active material layer 1212 is not coated in the region beyond the winding trailing edge C. The separator 123 wound on the outermost side of the electrode assembly 120 may include an upper separator region 1232, a lower separator region 1233, and an exposed region 1234 in the region beyond the winding trailing edge C. This configuration may allow the first substrate 1211 to form electrical contact at the outermost side of the battery and may provide crack prevention and internal impact absorption effects through the cushioning function of the separator 123.

The exposed region 1213 of the first electrode plate 121 may correspond to the exposed region 1234 of the separator 123, the upper region 1214 may correspond to the upper separator region 1232 of the separator 123, and the lower region 1215 may correspond to the lower separator region 1233 of the separator 123. The upper region 1214 may be located above the exposed region 1213, and the lower region 1215 may be located under the exposed region 1213. This upper and lower structure may be designed to ensure that the electrode assembly 120 is securely coupled to the battery case 110 such that no cracks occur at high cycle counts.

The exposed region 1213 may have a rectangular shape extending in a longitudinal direction (a leftward-rightward direction in FIG. 4) of the first electrode plate 121, and each of the upper region 1214 and the lower region 1215 may also be formed as a rectangular shape extending in the longitudinal direction in the same manner. This structure may optimize the contact area between the electrode assembly 120 and the case 110 such that electrical contact can be maintained stably.

The second electrode plate (e.g., the positive electrode plate) 122 according to the embodiment of the present disclosure may include a second substrate 1221 and a second active material layer 1222. In one or more embodiments, a second active material (e.g., a positive electrode active material including a transition metal oxide, such as LiCoO₂, LiNiO₂, or LiMn₂O₄) may be coated on the second substrate (e.g., a positive electrode substrate) 1221 to form the second active material layer (e.g., a positive electrode active material layer) 1222. The second substrate 1221 may include an aluminum (Al) foil.

The separator 123 may be located between the first electrode plate 121 and the second electrode plate 122 to prevent short circuit and to allow only the migration of lithium ions. As an example, the separator 123 may be interposed between the first electrode plate 121 and the second electrode plate 122. In one or more embodiments, the first electrode plate 121, the separator 123, and the second electrode plate 122 may be stacked and wound into a cylindrical shape as described above. The separator 123 may include polyethylene (PE) or polypropylene (PP).

The separator 123 according to the embodiment of the present disclosure may include a body portion 1231, an upper separator region 1232, a lower separator region 1233, and a cutting region. The body portion 1231 may be located on the outside of the first electrode plate 121 on which the first active material layer 1212 is stacked. The body portion 1231 may be wound up to the winding trailing edge C of the electrode assembly 120, and the upper separator region 1232 and the lower separator region 1233 extending beyond the winding trailing edge C of the body portion 1231 may extend in the longitudinal direction (the leftward-rightward direction in FIG. 4) of the separator 123.

The upper separator region 1232 may further extend from the winding trailing edge C of the first electrode plate 121 and the second electrode plate 122, and may be modified into various shapes as long as it is possible to wrap around the upper outermost side of the electrode assembly 120. The upper separator region 1232 may extend from the body portion 1231 of the separator 123, and may be modified into a shape corresponding to the upper region 1214 of the first electrode plate 121. As an example, the upper separator region 1232 may be a rectangular region extending in the longitudinal direction (the leftward-rightward direction in FIG. 4) of the separator 123.

The lower separator region 1233 may further extend from the winding trailing edge C of the first electrode plate 121 and the second electrode plate 122, and may be modified into various shapes as long as it is possible to wrap around the lower outermost side of the electrode assembly 120. The lower separator region 1233 may extend from the body portion 1231 of the separator 123, and may be modified into a shape corresponding to the lower region 1215 of the first electrode plate 121. As an example, the lower separator region 1233 may be a rectangular region extending in the longitudinal direction (the leftward-rightward direction in FIG. 4) of the separator 123.

The upper separator region 1232 and the lower separator region 1233 may be exposed to the outside (i.e., uncovered) while wrapping around the outermost side of the electrode assembly 120 at least one turn. Each of the upper separator region 1232 and the lower separator region 1233 may be formed in the shape of a strip, or may be symmetrical in the state in which the cutting region is interposed therebetween.

The first substrate 1211 may be exposed through the upper separator region 1232 and the lower separator region 1233 and may be in electrical contact with the case 110. The separator 123 may include an exposed region 1234 provided between the upper separator region 1232 and the lower separator region 1233, and the first substrate 1211 may be exposed through the exposed region 1234 and may be in electrical contact with the case 110. As an example, the exposed region 1234 may form a rectangular space.

The upper separator region 1232 may be finished by the upper finishing tape 140. The upper finishing tape 140 may be modified into various shapes as long as it is possible to couple the tape to the upper region 1214 of the first substrate 1211 through the upper separator region 1232.

As an example, the vertical width TW1 of the upper finish tape 140 may be less than the vertical width W1 of the upper separator region 1232. Because the vertical width TW1 of the upper finish tape 140 is less than the vertical width W1 of the upper separator region 1232, protrusion of the upper finish tape 140 to the outside of the upper separator region 1232 may be impeded, such that the contact area between the exposed region 1213 and the case 110 may be increased.

The upper finishing tape 140 and the lower finishing tape 141 may be coupled to the upper region 1214 and the lower region 1215 of the first substrate 1211 through the separator regions 1232 and 1233, respectively, thereby further reinforcing the structural stability of the electrode assembly 120. Each of the upper finishing tape 140 and the lower finishing tape 141 may serve as a cushion for the separator 123, thereby enhancing the resistance of the battery against external impact.

The lower separator region 1233 may be finished by the lower finishing tape 141. The lower finishing tape 141 may be modified into various shapes as long as it is possible to couple the lower region 1215 of the first substrate 1211 through the lower separator region 1233.

As an example, the vertical width TW2 of the lower finish tape 141 may be less than the vertical width W2 of the lower separator region 1233. Because the vertical width TW2 of the lower finish tape 141 is less than the vertical width W2 of the lower separator region 1233, protrusion of the lower finish tape 141 to the outside of the lower separator region 1233 may be impeded, such that the contact area between the exposed region 1213 and the case 110 may be increased.

In some examples, each of the vertical width W1 of the upper separator region 1232 and the vertical width W2 of the lower separator region 1233 may be between 5% to 40% of the total vertical width T of the electrode assembly 120. In the above setting conditions, the separator 123 may provide an appropriate cushioning effect at the upper and lower parts of the electrode assembly 120 while improving the durability of the electrode assembly 120. If each of the vertical widths W1 and W2 is less than 5% of the total vertical width T, the shock absorption effect may be insufficient, reducing the crack prevention effect. If each of the vertical widths W1 and W2 is greater than 40% of the total vertical width T, an unnecessary space may be increased, reducing the capacity efficiency of the battery. If each of the vertical widths W1 and W2 is within the above range, the shock absorption and crack prevention effects of the electrode assembly 120 may be maximized, and a sufficient cushioning function may be performed without an excessive increase in thickness.

In some examples, the vertical width AW of the exposed region 1213 of the first substrate 1211 may be between 60% to 95% of the total width of the electrode assembly 120. If the vertical width AW of the exposed region 1213 is less than 60% of the total width of the electrode assembly 120, the contact area between the first substrate 1211 and the case 110 may decrease, which may cause unstable electrical contact and increased internal resistance. If the vertical width AW of the exposed region 1213 is greater than 95% of the total width of the electrode assembly 120, the cushioning effect provided by the separator 123 may decrease, which may reduce the crack prevention effect. If the vertical width AW of the exposed region 1213 of the first substrate 1211 is 60% to 95% of the total vertical width T of the electrode assembly 120, contact between the first substrate 1211 and the case 110 may be sufficient, facilitating the flow of current, and internal resistance of the battery may be minimized, improving the output performance.

The electrode assembly 120 according to the present disclosure may have a composite finishing structure in which the separator 123 and the first substrate 1211 are disposed at the outermost side of the electrode assembly 120 (i.e., the separator 123 and the first substrate 1211 are found on the outside of the electrode assembly 120), whereby the finishing structure of the trailing edge portion is improved. Generally, if the negative electrode substrate ends at a winding trailing edge portion of a cylindrical battery as an outermost member and is electrically contacted with the case 110, cracks may occur in the part in contact with the finishing tape or nickel strips may be formed, whereby low voltage failure may occur, which may be solved by the present disclosure.

The electrode assembly 120 according to the present disclosure may simultaneously achieve a reduction in internal resistance and an improvement in output compared to a conventional electrode assembly. At the upper and lower ends of the electrode assembly 120, electrical contact may be maintained through a composite structure of the separator 123 and the negative electrode substrate, and the shock absorption and electrolyte accumulation prevention effects may be achieved.

The extension length D of the separator 123 and the length D1 of the exposed region 1213 of the first substrate 1211 may be the same, or in some cases, the extension length D of the separator 123 may be greater than the length D1 of the exposed region 1213. The extension length D of the separator 123 may be up to 5% greater than the length D1 of the exposed region 1213, and may be measured based on the outermost circumference of the electrode assembly 120. The length D1 of the exposed region 1213 of the first substrate 1211 may be equal to or exceed the length of the outermost circumference of the electrode assembly 120. This design may allow the separator 123 to completely or partially cover the exposed region 1213, preventing the electrolyte accumulation phenomenon that may occur at the outermost side of the electrode assembly 120 and enhancing electrical insulation to increase the stability of the battery. If the extension length D of the separator 123 is greater than the length D1 of the exposed region 1213, the shock absorption and crack prevention effects of the electrode assembly 120 may be further improved. If the length D1 of the exposed region 1213 is greater than the length of the outermost circumference, the contact area between the first substrate 1211 and the case 110 may be maximized, which may enhance electrical contact stability and output performance.

The electrode assembly 120 may be configured to prevent the accumulation of the electrolyte at the winding trailing edge C and to suppress the occurrence of cracks. The exposed region 1213 of the first substrate 1211 may be in electrical contact with the case 110, whereby the internal resistance of the battery may be reduced and the flow of current may be facilitated, and therefore the output performance may be improved. Because the upper and lower separator regions 1232 and 1233 are provided so as to wrap around the outermost side of the electrode assembly 120, the shock absorption and cushioning effect of the electrode assembly 120 may be maximized.

Hereinafter, the construction of several types of cylindrical secondary batteries 100 each including the electrode assembly 120 described above will be briefly described; however, the present disclosure is not limited thereto. For example, the electrode assembly 120 according to the present disclosure may also be applied to cylindrical secondary batteries 100 that have not yet been disclosed.

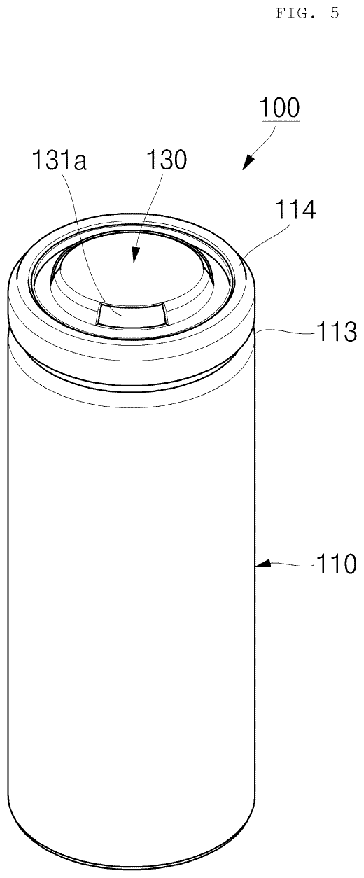

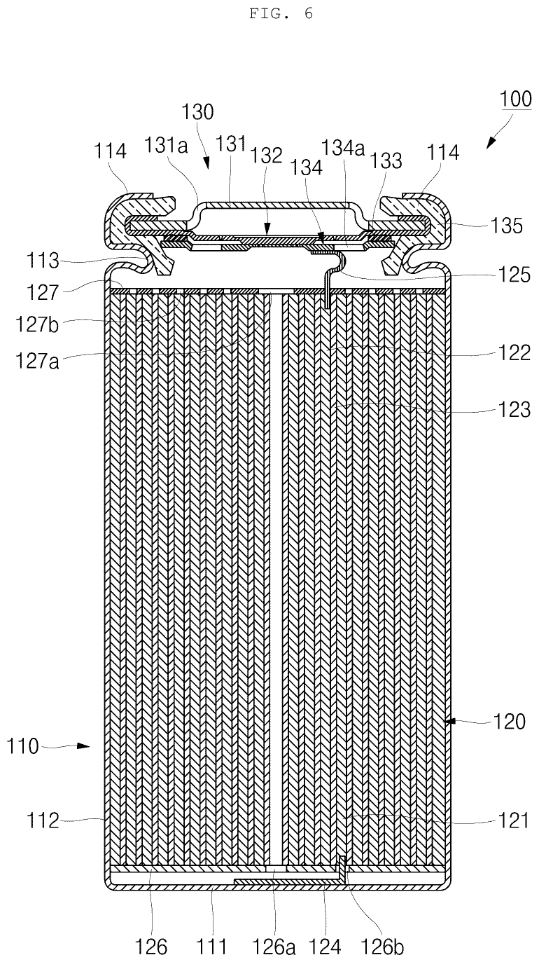

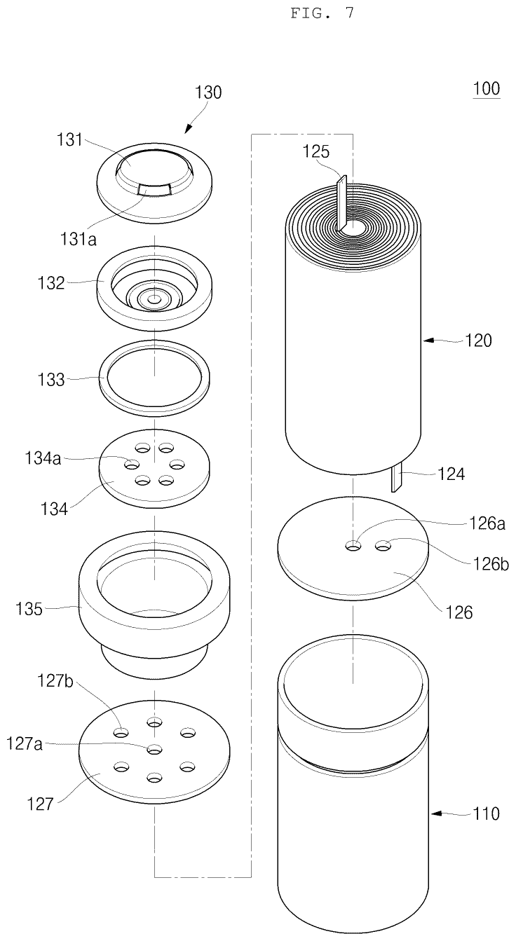

FIG. 5 is a perspective view of an example of a secondary battery 100 according to an embodiment of the present disclosure, FIG. 6 is a longitudinal sectional view of an example of the secondary battery 100 according to the embodiment of the present disclosure, and FIG. 7 is an exploded perspective view of an example of the secondary battery 100 according to the embodiment of the present disclosure. As shown in FIGS. 5 to 7, the secondary battery 100 according to the embodiment of the present disclosure may include a case 110, an electrode assembly 120, and a cap assembly 130. The secondary battery 100 may include at least one of a first electrode tab 124, a second electrode tab 125, a first insulating plate 126, and a second insulating plate 127.

The case 110 according to the embodiment of the present disclosure may be modified into various shapes as long as it is possible to receive the electrode assembly 120. The case 110 may include a circular bottom portion (which may be referred to as a ceiling portion in some cases) 111 and a cylindrical side wall portion 112 extending upward from the bottom portion 111 by a certain length. The top of the cylindrical case 110 may be open during a process of manufacturing the secondary battery 100. During a process of assembling the secondary battery 100, therefore, the electrode assembly 120 may be inserted into the cylindrical case 110 together with an electrolyte. In some examples, the cylindrical case 110 may include steel, a steel alloy, nickel-plated steel, stainless steel, aluminum, or an aluminum alloy. In some examples, the case 110 may include or be referred to as a can, a housing, or a cladding. In some examples, the cylindrical case 110 may include a beading portion 113 depressed inwardly (i.e., extending inwardly on the case) in the part thereof located under the cap assembly 130 to prevent the electrode assembly 120 and the cap assembly 130 from being ejected outward, and may include a crimping portion 114 bent inwardly in the part thereof located above the cap assembly 130.

The configuration of the electrode assembly 120 may be the same as or similar to the electrode assembly 120 according to the previous embodiment of the present disclosure, and therefore a detailed description thereof will be omitted. As an example, the electrode assembly 120 may be configured such that a first electrode plate 121, a separator 123, and a second electrode plate 122 are stacked and wound. A part of the separator 123 that wraps around the outermost side of the electrode assembly 120 may be open, and the first electrode plate 121 may be in contact with the case 110 through the open separator 123, whereby electrical connection may be achieved.

The electrode assembly 120 may be received in the cylindrical case 110. The electrode assembly 120 may include a first electrode plate 121 coated with a negative electrode active material (e.g., graphite or carbon), a second electrode plate 122 coated with a positive electrode active material (e.g., a transition metal oxide (LiCoO₂, LiNiO₂, or LiMn₂O₄), and a separator 123 located between the first electrode plate 121 and the second electrode plate 122 to prevent short circuit and to allow only the migration of lithium ions. In some examples, the first electrode plate 121, the second electrode plate 122, and the separator 123 may be wound into a cylindrical shape. In some examples, the first electrode plate 121 may include a copper (Cu) or nickel (Ni) foil, the second electrode plate 122 may include an aluminum (Al) foil, and the separator 123 may include polyethylene (PE) or polypropylene (PP). In some examples, a first electrode tab 124 protruding and extending downward by a certain length may be welded to the first electrode plate 121, and a second electrode tab 125 protruding upward by a certain length may be welded to the second electrode plate 122. The opposite configuration may also be possible. In some examples, the first electrode tab 124 may include copper or nickel, and the second electrode tab 125 may include aluminum. The first electrode plate 121 may be electrically connected to the case 110 via the first electrode tab 124, and the second electrode plate 122 may be electrically connected to the cap assembly 130 via the second electrode tab 125. In some examples, the electrode assembly 120 may include or be referred to as an electrode group, an electrode body, or a jelly-roll. In the following description, in some cases, reference numerals of the first electrode plate 121 and/or the second electrode plate 122 may be reversed.

As described above, the electrode assembly 120 may have a composite finishing structure in which the separator 123 and the first substrate 1211 are disposed at the outermost side of the electrode assembly 120, whereby the finishing structure of the trailing edge portion is improved, and a detailed description thereof will be omitted.

In some examples, the first electrode tab 124 of the electrode assembly 120 may be welded to the bottom portion 111 of the cylindrical case 110. Therefore, the cylindrical case 110 may serve as a negative electrode. The second electrode tab 125 may be welded to the bottom portion 111 of the cylindrical case 110, in which case the cylindrical case 110 may serve as a positive electrode.

In some examples, a first insulating plate 126, which is coupled to the cylindrical case 110 and has a first hole 126a formed in the center thereof and a second hole 126b formed in an outer side thereof, may be inserted between the electrode assembly 120 and the bottom portion 111. The first insulating plate 126 may prevent electrical contact between the electrode assembly 120 and the bottom portion 111 of the cylindrical case 110. In some examples, the first insulating plate 126 may prevent electrical contact between the second electrode plate 122 of the electrode assembly 120 and the bottom portion 111. In some examples, if a large amount of gas is generated due to abnormality of the secondary battery 100, the first hole 126a may allow the gas to quickly move upward therethrough, and the second hole 126b may allow the first electrode tab 124 to extend therethrough and be welded to the bottom portion 111.

In some examples, a second insulating plate 127, which is coupled to the cylindrical case 110 and has a first hole 127a formed in the center thereof and a plurality of second holes 127b formed in an outer side thereof, may be inserted between the electrode assembly 120 and the cap assembly 130. The second insulating plate 127 may prevent electrical contact between the electrode assembly 120 and the cap assembly 130. In some examples, the second insulating plate 127 may prevent electrical contact between the first electrode plate 121 of the electrode assembly 120 and the cap assembly 130. In some examples, if a large amount of gas is generated due to an abnormality of the secondary battery 100, the first hole 127a may allow the gas to quickly move to the cap assembly 130 therethrough, and one of the second holes 127b may allow the second electrode tab 125 to extend therethrough and be welded to the cap assembly 130. The remaining second holes 127b may allow an electrolyte to flow quickly to the electrode assembly 120 therethrough during an electrolyte injection process.

The cap assembly 130 may be modified into various shapes as long as it is possible to seal the case 110. As an example, the cap assembly 130 may include a cap-up 131, a safety vent 132 coupled to the cap-up 131, a lower cap which is coupled to the safety vent 132 and to which the second electrode tab 125 is electrically connected, and an insulating gasket 135 interposed between the upper cap 131 and the safety vent 132, the insulating gasket in contract with an interior of the case 110.

As an example, the cap assembly 130 may include a upper cap 131 having a plurality of through-holes 131a, a safety vent 132 coupled to the upper cap 131, a connecting ring 133 located under the safety vent 132, and a lower cap 134 located under the safety vent 132 and the connecting ring 133, having a number of through-holes 134a, and electrically connected to the second electrode tab 125. In some examples, the cap assembly 130 may further include an insulating gasket 135 configured to insulate the upper cap 131, the safety vent 132, and the lower cap 134 from the side wall portion 112 of the cylindrical case 110. In some examples, the cap assembly 130 may include or be referred to as a cap, a cap group, a cap assembly, a lid, a cover, or a top.

In some examples, the insulating gasket 135 interposed between the upper cap 131 and the safety vent 132 and the case 110 may be substantially pressed between the beading portion 113 and the crimping portion 114 formed on the side wall portion 112 of the cylindrical case 110. In some examples, the through-hole 131a of the upper cap 131 and the through-hole 134a of the lower cap 134 may discharge internal gas to the outside if abnormal internal pressure occurs in the cylindrical case 110. In some examples, the internal gas may reverse the safety vent 132 upward through the through-hole 134a of the lower cap 134, the safety vent 132 may be electrically disconnected from the lower cap 134, and the safety vent 132 may be torn (opened), allowing the internal gas to be released to the outside through the through-hole 131a of the upper cap 131.

In some examples, an electrolyte (not shown) may be injected into the cylindrical case 110, which may allow lithium ions generated by electrochemical reaction at the first electrode plate 121 and the second electrode plate 122 in the battery to move during charging and discharging. The electrolyte may include a non-aqueous organic electrolyte, which is a mixture of lithium salt and a high-purity organic solvent. In some examples, the electrolyte may include a polymer using polyelectrolyte or a solid electrolyte.

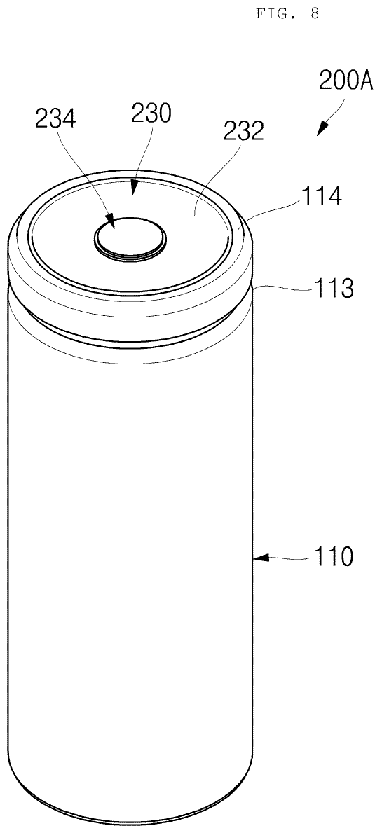

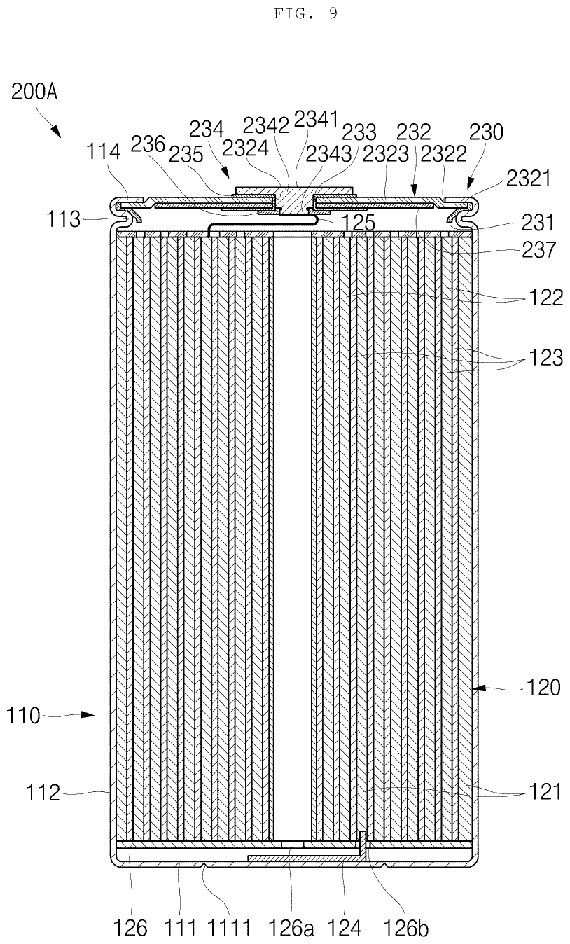

FIG. 8 is a perspective view of an example of a secondary battery 200A according to another embodiment of the present disclosure, and FIG. 9 is a longitudinal sectional view of an example of the secondary battery 200A according to the other embodiment of the present disclosure. As shown in FIGS. 8 and 9, the secondary battery 200A may include a cap assembly 230, a case 110, and an electrode assembly 120.

The case 110 and the electrode assembly 120 may be the same as or similar to those described above, and therefore a description thereof will be omitted. However, the cylindrical case 110 may have a beading portion 113 depressed/extending inwardly in the part thereof located under the cap assembly 230 to prevent the cap assembly 230 from being ejected outward, and may have a crimping portion 114 bent/bending inwardly in the part thereof located above the cap assembly 230. A safety groove vent 1111 may be provided in a bottom portion 111 of the cylindrical case 110. In some examples, the safety groove vent 1111 may be provided in an approximately circular ring shape or a C shape. In some examples, the safety groove vent 1111 may include or be referred to as a notch, a recess, or a groove.

The cap assembly 230 may include a rivet terminal 234 to which a second electrode tab 125 is electrically connected, an insulating gasket 135 coupled to the outside of the rivet terminal 234, and a cap plate 232 coupled to the outside of the insulating gasket 135 and coupled to the case 110. The insulating gasket 135 may include or be referred to as a second insulating gasket.

In some examples, the cap assembly 230 may include a first insulating gasket 231, a cap plate 232, a second insulating gasket 233, and a rivet terminal 234. In some examples, the cap assembly 230 may further include an upper insulator 235, a lower insulator 236, and an inner insulator 237.

The first insulating gasket 231 may be interposed between the beading portion 113 and the crimping portion 114 provided at the case 110. In some examples, an upper end of the first insulating gasket 231 may be located between the beading portion 113 and the crimping portion 114, and a lower end of the first insulating gasket 231 may be located in the beading portion 113. In some examples, the first insulating gasket 231 may include an insulator that does not react with an electrolyte. Non-limiting examples of the materials for the first insulating gasket 231 may include polypropylene (PP), polyethylene (PE), ethylene propylene diene monomer (EPDM), or nitrile butadiene rubber (NBR). The first insulating gasket 231 may isolate the inside and the outside of the case 110 from each other, preventing the electrolyte in the case 110 from leaking to the outside or foreign matter (e.g., moisture or dust) from being introduced into the case 110.

The cap plate 232 may be coupled and fixed between the beading portion 113 and the crimping portion 114 in the state in which the first insulating gasket 231 is interposed therebetween. In some examples, the cap plate 232 may include a cap plate periphery region 2321, a cap plate slope region 2322, and a cap plate center region 2323. The cap plate center region 2323 may include a terminal hole 2324 through which the second insulating gasket 233 and the rivet terminal 234 are coupled. Non-limiting examples of materials for the cap plate 232 may include aluminum, copper, nickel, iron, or an alloy thereof. In some examples, the cap plate 232 may include or be referred to as a cap, a upper cap, a plate, a cover, a lid, or a top.

The cap plate periphery region 2321 may be coupled between the beading portion 113 and the crimping portion 114. In some examples, a side surface and an inner surface (a lower surface) of the cap plate periphery region 2321 may be in tight contact with the first insulating gasket 231, and an outer surface (an upper surface) of the cap plate periphery region 2321 may be in tight contact with the crimping portion 114. In some examples, the outer surface of the cap plate periphery region 2321 may be electrically connected to an inner surface of the crimping portion 114. Therefore, the case 110 and the cap plate 232 may have the same polarity.

The cap plate slope region 2322 may extend from the cap plate periphery region 2321 and may be inclined upward. The cap plate slope region 2322 may connect the cap plate periphery region 2321 and the cap plate center region 2323 to each other.

The cap plate center region 2323 may extend from the cap plate slope region 2322. The cap plate center region 2323 may include an approximately flat outer surface (an upper surface) and an approximately flat inner surface (a lower surface), which is opposite the outer surface. The terminal hole 2324 may be formed through the cap plate center region 2323. In some examples, an outer surface of the crimping portion 114 and the outer surface of the cap plate center region 2323 may generally form the same plane.

The second insulating gasket 233 may be coupled to the terminal hole 2324. In some examples, the second insulating gasket 233 may cover an inner wall of the terminal hole 2324, a part of the outer surface of the cap plate center region 2323, and a part of the inner surface of the cap plate center region 2323. The material of the second insulating gasket 233 may be similar to the material of the first insulating gasket 231. The second insulating gasket 233 may include or be referred to as a sealing gasket or a sealing insulator.

The rivet terminal 234 may be coupled through the second insulating gasket 233. For example, the rivet terminal 234 may be coupled through the terminal hole 2324 of the cap plate 232.

In some examples, the rivet terminal 234 may include a rivet head 2341 located on an outer surface of the cap plate 232, a rivet body 2342 located in the terminal hole 2324, and a rivet leg 2343 located on an inner surface of the cap plate 232. In some examples, the rivet head 2341, the rivet body 2342, and the rivet leg 2343 may be integrally formed, and may have an approximately T-shaped sectional shape. Non-limiting examples of materials which may be used for the rivet terminal 234 may include aluminum, copper, nickel, iron, or an alloy thereof.

A positive electrode lead tab 125 may be electrically connected to the rivet leg 2343 of the rivet terminal 234. In some examples, the positive electrode lead tab 125 may be welded to the rivet leg 2343. The positive electrode lead tab 125 may be referred to as a second electrode tab 125 or a positive electrode tab.

Thus, the rivet terminal 234 may have the characteristics of a positive electrode. In some examples, the cap plate 232 may serve as a negative electrode terminal, and the rivet terminal 234 may serve as a positive electrode terminal. For example, the cap plate 232 may be electrically connected to the crimping portion 114 of the case 110 such that the cap plate 232 has the characteristics of a negative electrode, and the rivet terminal 234 may be electrically connected to the second electrode tab 125, which is a positive electrode lead tab, such that the rivet terminal 234 has the characteristics of a positive electrode. Thus, in the present disclosure, two terminals (a positive electrode terminal and a negative electrode terminal) may be provided simultaneously at an upper region 1214 of the cylindrical secondary battery 200A.

The upper insulator 235 may be provided between the rivet terminal 234 and the cap plate 232. In some examples, the upper insulator 235 may be interposed between the rivet head 2341 and the cap plate center region 2323.

The lower insulator 236 may be interposed between the rivet body 2342 and/or the rivet leg 2343 and the cap plate center region 2323. In some examples, the lower insulator 236 may be interposed between the rivet leg 2343 and the second insulating gasket 233 and/or the inner insulator 237.

The inner insulator 237 may be further provided on the inner surface of the cap plate 232. In some examples, the inner insulator 237 may be provided at the cap plate center region 2323. In some examples, an inner insulator 237 may be provided on the inner surface of the cap plate center region 2323. In some examples, the inner insulator 237 may be provided from the terminal hole 2324 provided in the cap plate center region 2323 to the cap plate slope region 2322.

In some examples, each of the insulators 235, 236, and 237 may include an insulator that does not react with an electrolyte. As non-limiting examples, each of the insulators 235, 236, and 237 may include materials such as polypropylene (PP), polyethylene (PE), ethylene propylene diene terpolymer (EPDM), or nitrile butadiene rubber (NBR). In some examples, each of the insulators 235, 236, and 237 may be provided as a liquid, may be coated on the cap plate 232, and may be hardened, or each of the insulators 235, 236, and 237 may be separately provided and assembled to the cap plate 232.

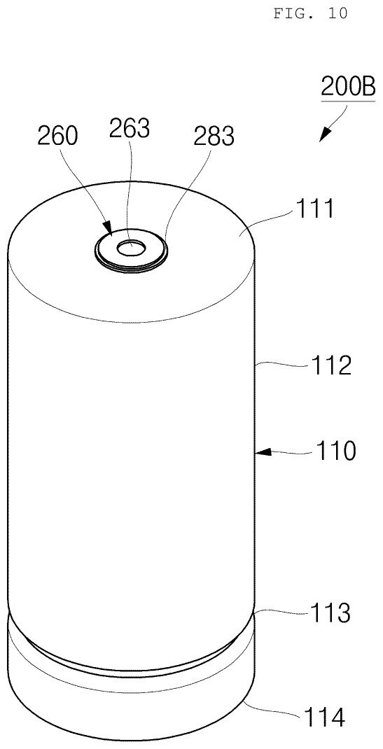

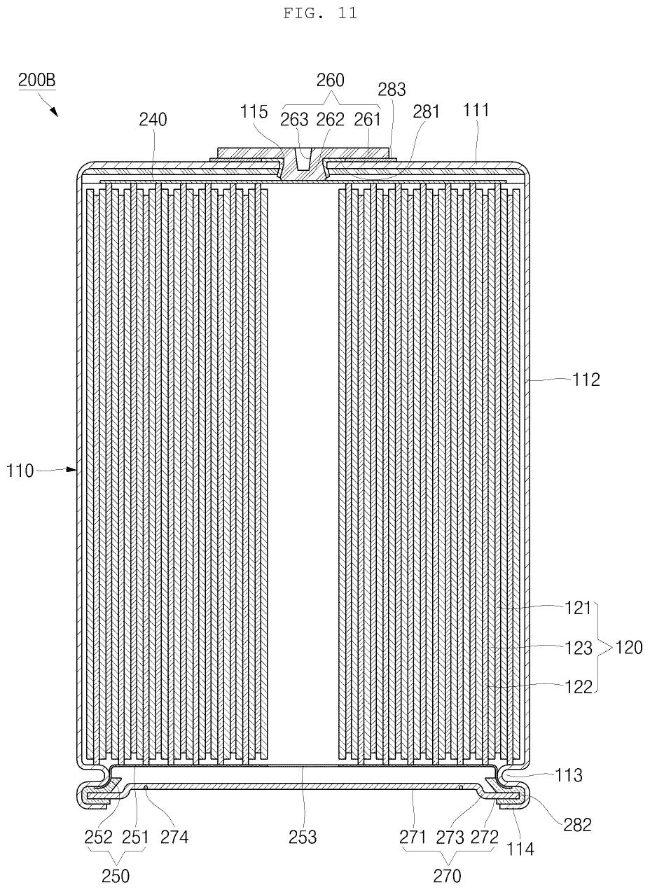

FIG. 10 is a perspective view of an example of a secondary battery 200B according to yet another embodiment of the present disclosure, and FIG. 11 is a longitudinal sectional view of an example of the secondary battery 200B according to the yet another embodiment of the present disclosure.

As shown in FIGS. 10 and 11, the secondary battery 200B according to the yet another embodiment of the present disclosure may include a case 110, an electrode assembly 120, a positive electrode current collecting plate 240, a negative electrode current collecting plate 250, a rivet terminal 260, and a cap plate 270.

The case 110 may include a circular ceiling portion (which may be referred to as a bottom portion in some cases) 111 and a side wall portion 112 extending downward from an edge of the ceiling portion 111 by a certain length. The ceiling portion 111 and the side wall portion 112 of the case 110 may be integrally formed.

The ceiling portion 111 may have a flat circular plate shape and may be provided with a terminal hole 115 formed through the center thereof. The rivet terminal 260 may be inserted into and coupled to the terminal hole 115 of the ceiling portion 111. A first gasket 281 for sealing and electrical insulation may be further interposed between the terminal hole 115 and the rivet terminal 260. The first gasket 281 may be inserted into the terminal hole 115 and may extend upwardly of the ceiling portion 111. The first gasket 281 may electrically isolate the rivet terminal 260 and the case 110 from each other by blocking the contact between the rivet terminal 260 and the case 110. The terminal hole 115 provided in the ceiling portion 111 of the case 110 may be sealed by the first gasket 281. The first gasket 281 may be made of a resin such as polyethylene (PE), polypropylene (PP), or polyethylene terephthalate (PET).

The top of the case 110 may be open during a process of manufacturing the cylindrical secondary battery 200B. Therefore, the electrode assembly 120 may be inserted through the open top of the case 110 during the process of manufacturing the cylindrical secondary battery 200B. After the electrode assembly 120 is inserted and an electrolyte is injected into the case 110, the cap plate 270 may be coupled to the open top of the case 110 to seal the case 110. In some examples, if the case 110 is turned over, the ceiling portion 111 may be located at a lower part of the case 110, and the cap plate 270 may be coupled to an upper end of the case 110.

The electrode assembly 120 may include a first electrode plate 121, a second electrode plate 122, and a separator 123. The first electrode plate 121, the second electrode plate 122, and the separator 123 may be stacked and wound from winding leading edges thereof, whereby the electrode assembly 120 may be formed in a cylindrical shape. In the electrode assembly 120, a negative electrode uncoated portion that is not coated with a negative electrode active material may protrude downward from the first electrode plate 121, and a positive electrode uncoated portion that is not coated with a positive electrode active material may protrude upward from the second electrode plate 122. The opposite configuration may also be possible.

The detailed configuration of the electrode assembly 120 configured such that the first substrate 1211 of the first electrode plate 121 is exposed to the exposed region 1234 provided at the separator 123 so as to be in contact with the case 110 has been described above, and therefore a detailed description thereof will be omitted.

The positive electrode current collecting plate 240 may be a circular metal plate having a shape corresponding to the shape of an upper surface of the electrode assembly 120. The area (or the size) of the positive electrode current collecting plate 240 may be equal to or less than the area (or the size) of the upper surface of the electrode assembly 120. The positive electrode current collecting plate 240 may be made of aluminum (Al). The positive electrode current collecting plate 240 may be fixed and electrically connected to the first electrode plate 121 exposed upwardly of the electrode assembly 120 by welding in the state in which a lower surface of the positive electrode current collecting plate 240 is in contact with the upper surface of the electrode assembly 120. The positive electrode current collecting plate 240 may be fixed and electrically connected to the rivet terminal 260 by welding in the state in which an upper surface of the positive electrode current collecting plate 240 is in contact with a lower surface of the rivet terminal 260. The positive electrode current collecting plate 240 may be a current flow path between the first electrode plate 121 of the electrode assembly 120 and the rivet terminal 260. As an example, the positive electrode current collecting plate 240 may be referred to as a second current collecting plate, and the negative electrode current collecting plate 250 may be referred to as a first current collecting plate.

The negative electrode current collecting plate 250 may include a circular flat portion 251 corresponding to a lower surface of the electrode assembly 120 and an extension portion 252 extending upward from an edge of the flat portion 251. An upper surface of the flat portion 251 may be in contact with the lower surface of the electrode assembly 120. The upper surface of the flat portion 251 may be fixed and electrically connected to the second electrode plate 122 exposed downwardly of the electrode assembly 120 by welding in the state in which the upper surface of the flat portion 251 is in contact with the lower surface of the electrode assembly 120. A through-hole 253 may be formed in the flat portion 251. The through-hole 253 may be formed in the flat portion 251 in one or more. In some examples, the through-hole 253 may be a movement path of an electrolyte injected into the case 110 or a movement path of internal gas.

The extension portion 252 may be bent from an edge of the flat portion 251 and may extend downward. The extension portion 252 may be in contact with and coupled to a beading portion 113 of the case 110. Therefore, the extension portion 252 may be formed in a round shape corresponding to the beading portion 113. For example, the extension portion 252 may be coupled to an inner surface of the beading portion 113 of the case 110 by welding in a state of being in contact therewith. A second gasket 282 may be located under the extension portion 252, whereby the negative electrode current collecting plate 250 may be electrically insulated from the cap plate 270. The extension portion 252 may be provided in plural so as to be spaced apart from each other along the edge of the flat portion 251. The negative electrode current collecting plate 250 may be a current flow path between the second electrode plate 122 of the electrode assembly 120 and the case 110. For example, the case 110 may be a negative electrode terminal.

The rivet terminal 260 may be inserted into the terminal hole 115 provided in the ceiling portion 111 of the case 110 so as to be electrically connected to the positive electrode current collecting plate 240. For example, the rivet terminal 260 may be a positive electrode terminal. The rivet terminal 260 and the case 110 may have different polarities. The rivet terminal 260 may be made of a material identical or similar to the material of each of the positive electrode current collecting plate 240 and the first electrode plate 121. The diameter of the part of the rivet terminal 260 exposed upwardly of the case 110 and the diameter of the part of the rivet terminal 260 located in the case 110 may be greater than the diameter of the part of the rivet terminal 260 located in the terminal hole 115.

The rivet terminal 260 may include a head 261 exposed on the top of the case 110 (as illustrated in FIG. 11) and a fastening portion 262 located in the case 110 and coupled to the positive electrode current collecting plate 240. The rivet terminal 260 may be coupled to the terminal hole 115 of the case 110 in an inward direction from the outside. In such a case, the head 261 may be located outside the case 110. The fastening portion 262 may be compression-deformed (compression-molded) by riveting and pressed against a lower part of the ceiling portion 111 in the state in which the first gasket 281 is interposed therebetween. The fastening portion 262 may have a diameter gradually increasing in a direction from the terminal hole 115 to the inside of the case 110. For example, the diameter of a lower end of the fastening portion 262 may be greater than the diameter of an upper end of the fastening portion 262. The upper end of the fastening portion 262 may refer to the part of the fastening portion 262 connected to the head 261. The diameter of the lower end of the fastening portion 262 may be greater than the diameter of the terminal hole 115, and the diameter of the terminal hole 115 may be greater than the diameter of the upper end of the fastening portion 262. The head 261 may be in tight contact with an upper part of the ceiling portion 111 in the state in which the first gasket 281 is interposed therebetween. In such a case, the first gasket 281 may be interposed between the rivet terminal 260 and the terminal hole 115. The rivet terminal 260 may be electrically connected to the first electrode plate 121 of the electrode assembly 120 via the positive electrode current collecting plate 240.

An insulating gasket 283 may be further interposed between the head 261 and the ceiling portion 111 of the case 110. For example, the head 261 may be located under the ceiling portion 111, and the insulating gasket 283 configured to block electrical contact between the rivet terminal 260 and the case 110 may be disposed in the region where the head 261 and the ceiling portion 111 overlap each other on the plane. The diameter of the insulating gasket 283 may be greater than the diameter of the head 261. Therefore, the outer circumference (or the tip) of the insulating gasket 283 may extend outwardly of the head 261 and be exposed.

The first gasket 281 may be interposed between the fastening portion 262 and the terminal hole 115 of the case 110, and an upper end of the first gasket 281 may extend between the head 261 and the ceiling portion 111 of the case 110. In such a case, the tip of the upper end of the first gasket 281 may be in contact with the insulating gasket 283. For example, the first gasket 281 and the insulating gasket 283 may be interposed between the rivet terminal 260 and the ceiling portion 111 of the case 110 to electrically insulate the rivet terminal 260 and the case 110 from each other while sealing the same. The first gasket 281 and the insulating gasket 283 may be integrally formed.

The rivet terminal 260 may further include a welding recess 263 having a certain depth from an upper surface of the head 261 in a direction toward the fastening portion 262. For example, the welding recess 263 may be formed through the center of the head 261 and may extend downward from a lower part of the fastening portion 262. The thickness of the fastening portion 262 may be reduced by the welding recess 263, whereby the fastening portion 262 and the positive electrode current collecting plate 240 may be easily welded to each other outside the case 110.

The cap plate 270 may be coupled and fixed between the beading portion 113 depressed inwardly of the case 110 and a crimping portion 114 bent inwardly of the case 110. The cap plate 270 may be a circular metal plate, and may be coupled to a lower end of the case 110. A lower surface of the cap plate 270 may be exposed to the outside. The cap plate 270 may be coupled to the lower end of the case 110 in the state in which the second gasket 282 is interposed therebetween, whereby electrical connection with the case 110 may be prevented. Because the cap plate 270 is not electrically connected to the positive electrode or the negative electrode of the electrode assembly 120, the cap plate 270 may not have a separate electrical polarity.

The cap plate 270 may include a first region 271 located above the negative electrode current collecting plate 250, a second region 272 located outside the first region 271, and a third region 273 located between the first region 271 and the second region 272. The first region 271 may be located in the center of the cap plate 270 and may have a relatively large area. The second region 272 may be formed to protrude farther upward than the first region 271. The second region 272 may be interposed between the beading portion 113 and the crimping portion 114 of the case 110 and may be coupled to the case 110. The third region 273 may be formed to be inclined or bent to connect the first region 271 and the second region 272, which have different heights, to each other. The second region 272 may be fixed in a state of being located between the beading portion 113 and the crimping portion 114 of the case 110. For example, the second region 272 may be seated on the second gasket 282 in the state in which the second gasket 282 is disposed on the beading portion 113 of the case 110. Subsequently, the crimping portion 114 of the case 110 may be bent inwardly of the cap plate 270 to press the second gasket 282, whereby the cap plate 270 and the case 110 may be coupled to each other. The second gasket 282 may be tightly fitted between the case 110 and the cap plate 270. The second gasket 282 may be in tight contact with the inside of each of the beading portion 113 and the crimping portion 114. The tip of the second gasket 282 located between the cap plate 270 and the crimping portion 114 may be formed to extend farther inwardly of the case 110 than the tip of the crimping portion 114, whereby the tip of the second gasket 282 may be exposed to the outside. The tip of the second gasket 282 located between the cap plate 270 and the beading portion 113 may be formed to protrude farther inwardly of the case 110 than the beading portion 113. The second gasket 282 may be made of a resin such as polyethylene (PE), polypropylene (PP), or polyethylene terephthalate (PET).

The cap plate 270 may include a vent 274 formed in the first region 271 and configured be opened at a set pressure. The vent 274 may have a thickness less than the thickness of other regions of the cap plate 270. The vent 274 may be a notch formed in a lower surface of the cap plate 270 to extend in an upward direction. The vent 274 may be formed in the part of the first region 271 adjacent to the third region 273. In some examples, the vent 274 may be formed in a continuous notch shape and may be circular. In some examples, the vent 274 may be formed in the shape in which notches are spaced apart from each other.

The secondary battery 200B may include a cap plate 270 configured to block a lower side of the case 110. In some examples, the secondary battery 200B may include a rivet terminal 260 coupled to an upper side of the case 110 in the state in which the insulating gasket 283 is interposed therebetween.

The first electrode plate 121 may be electrically connected to the case 110 via the first current collecting plate, which is the negative electrode current collecting plate 250, and the second electrode plate 122 may be electrically connected to the rivet terminal 260 via the second current collecting plate, which is the positive electrode current collecting plate 240.

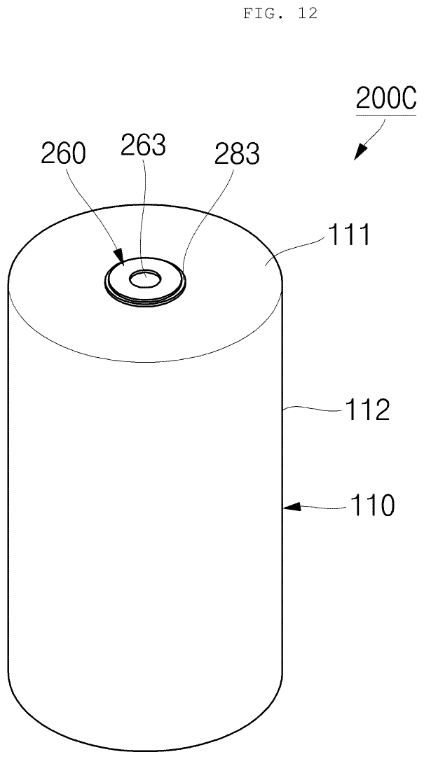

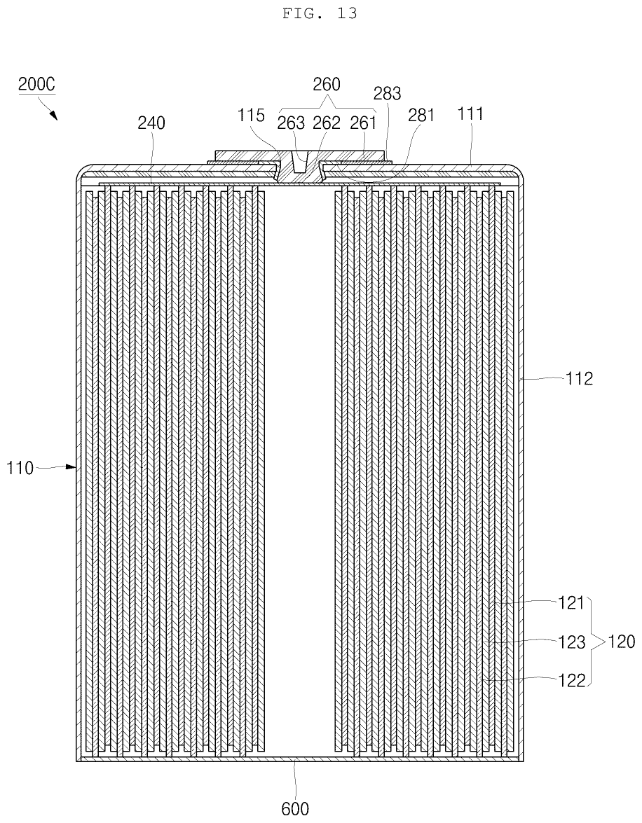

FIG. 12 is a perspective view of an example of a secondary battery 200C according to still yet another embodiment of the present disclosure, and FIG. 13 is a longitudinal sectional view of an example of the secondary battery 200C according to the still yet another embodiment of the present disclosure. As shown in FIGS. 12 and 13, the secondary battery 200C according to the still yet another embodiment of the present disclosure is identical or similar in construction to the secondary battery 200B shown in FIG. 11 except that a beading portion 113 and a crimping portion 114 are not provided. Therefore, a detailed description of configurations similar or identical to the configurations described above will be omitted. The secondary battery 200C may include a case 110, an electrode assembly 120, and a cap plate 600.

The cap plate 600, which is configured to block a lower side of the case 110, may be fixed to the case 110 by welding while in contact with the case 110. The case 110 may receive the electrode assembly 120, and the electrode assembly 120 may be located in the case 110 to allow electrochemical reaction to occur for charging and discharging. A first electrode plate 121, which is a negative electrode plate, may be electrically connected to the case 110 and the cap plate 600. The first electrode plate 121 and the case 110 may be electrically connected to each other in surface contact with each other, and a lower side of the first electrode plate 121 may be welded or compression-coupled to the cap plate 600 to reliably transmit a negative electrode current to the case 110. In the secondary battery 200C, therefore, the current flow may be optimized, internal resistance may be reduced, and the output performance of the battery may be improved.

A second electrode plate 122, which is a positive electrode plate, may be connected to a rivet terminal 260 via a positive electrode current collecting plate 240. The positive electrode current collecting plate 240 may be connected such that current is transmitted from a positive electrode to the outside via the rivet terminal 260, and a positive electrode tab and the positive electrode current collecting plate 240 may be connected to each other and then welded to the rivet terminal 260, whereby stable current flow may be ensured. The rivet terminal 260 may be connected to an external terminal in a state of being electrically insulated from the case 110 to maintain stable electrical connection between the positive electrode and the negative electrode.

The structure according to this embodiment may be designed such that the electrode assembly 120 and the cap plate 600 are in tight contact with each other to evenly distribute an electrolyte, and a manufacturing process may be simplified by omitting the beading portion 113 and the crimping portion 114, thereby reducing production costs.

The electrode assembly 120 according to the present disclosure will be described in more detail.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c}(0.90≤a≤1.8, 0≤b≤0.5, 0≤c≤0.05); LiₐMn_{2-b}X_{b}O_{4-c}D_{c}(0.90≤a≤1.8, 0≤b≤0.5, 0≤c≤0.05); LiₐNi_{1-b-c}Co_{b}X_{c}O_{2-α}D_{α}(0.90≤a≤1.8, 0≤b≤0.5, 0≤c≤0.5, 0<α<2); LiₐNi_{1-b-c}Mn_{b}X_{c}O_{2-α}D_{α}(0.90≤a≤1.8, 0≤b≤0.5, 0≤c≤0.5, 0<α<2); LiₐNi_{b}Co_{c}L¹ _{d}GₑO₂(0.90≤a≤1.8, 0≤b≤0.9, 0≤c≤0.5, 0≤d≤0.5, 0≤e≤0.1); LiₐNiG_{b}O₂(0.90≤a≤1.8, 0.001≤b≤0.1); LiₐCoG_{b}O₂(0.90≤a≤1.8, 0.001≤b≤0.1); LiₐMn_{1-b}G_{b}O₂(0.90≤a≤1.8, 0.001≤b≤0.1); LiₐMn₂G_{b}O₄(0.90≤a≤1.8, 0.001≤b≤0.1); LiₐMn_{1-g}G_{g}PO₄(0.90≤a≤1.8, 0≤g≤0.5); Li_{3-f})Fe₂(PO₄)₃(0≤f≤2); LiₐFePO₄(0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

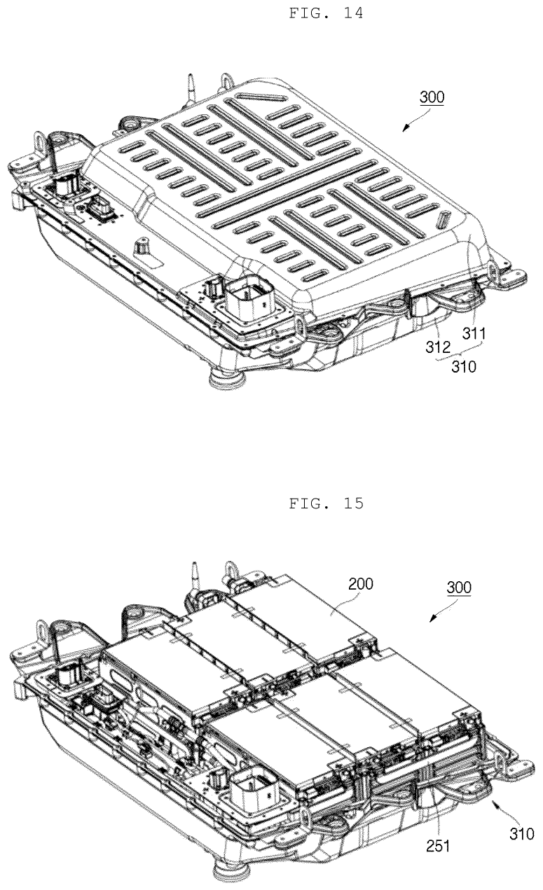

The batteries according to the above-described embodiments may be used to manufacture a battery pack. FIGS. 14 and 15 are perspective views showing a battery pack including the exemplary secondary battery according to the present disclosure. Referring to FIGS. 14 and 15, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

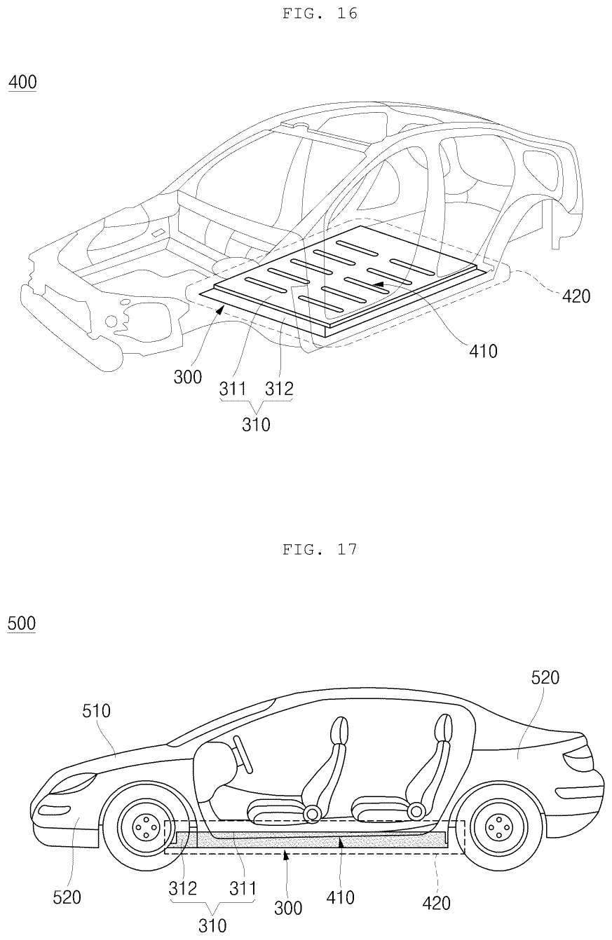

FIGS. 16 and 17 are, respectively, a perspective view and a side view showing vehicles 400 and 500 including the exemplary battery pack 300 according to the present disclosure.

In FIG. 16, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 17, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

As is apparent from the above description, according to embodiments of the present disclosure, a composite finishing structure capable of preventing the occurrence of cracks at a trailing edge portion of an electrode assembly and nickel band formation is provided, whereby it is possible to prevent the occurrence of cracks at a finishing tape facing part and to suppress the formation of a nickel band due to electrolyte accumulation, and therefore it is possible to provide a secondary battery with improved battery performance and stability.

However, the effects achievable through the present invention are not limited to those described above, and other technical effects not mentioned can be clearly understood by those skilled in the art from the description of the invention provided above.

Although a few embodiments of the present disclosure have been shown and described, it would be appreciated by those skilled in the art that various changes and modifications may be made in this embodiment without departing from the principles and technical idea of the disclosure.

What is claimed is:

1. An electrode assembly comprising:
a first electrode plate comprising a first substrate and a first active material layer;
a second electrode plate comprising a second substrate and a second active material layer; and
a separator interposed between the first electrode plate and the second electrode plate,
wherein the first electrode plate, the second electrode plate, and the separator are stacked and wound, and
wherein the separator comprises:
an upper separator region extending beyond a winding trailing edge of each of the first electrode plate and the second electrode plate, the upper separator region configured to wrap around an upper outermost side of the electrode assembly; and
a lower separator region extending beyond the winding trailing edge of each of the first electrode plate and the second electrode plate, the lower separator region configured to wrap a lower outermost side of the electrode assembly.

2. The electrode assembly as claimed in claim 1, wherein the first substrate is exposed between the upper separator region and the lower separator region so as to be in electrical contact with the case.

3. The electrode assembly as claimed in claim 2, wherein the first substrate and the separator wrap around an outermost side of the electrode assembly, the outermost side comprising the upper outermost side and the lower outermost side.

4. The electrode assembly as claimed in claim 2, wherein:
the separator comprises an exposed region provided between the upper separator region and the lower separator region, and
the first substrate is exposed so as to be in electrical contact with the case through the exposed region.

5. The electrode assembly as claimed in claim 1, wherein the upper separator region and the lower separator region are uncovered while wrapping around an outermost side of the electrode assembly at least one turn, the outermost side comprising the upper outermost side and the lower outermost side.

6. The electrode assembly as claimed in claim 1, wherein:
the upper separator region ends, moving farther away from the winding trailing edge of each of the first electrode plate and the second electrode plate, with an upper finishing tape; and
the lower separator region ends, moving farther away from the winding trailing edge of each of the first electrode plate and the second electrode plate, with a lower finishing tape.

7. A secondary battery comprising:
an electrode assembly comprising:
a first electrode plate comprising:
a first substrate; and
a first active material layer;
a separator; and
a second electrode plate comprising:
a second substrate; and
a second active material layer,
wherein the first electrode plate, the separator, and the second electrode plate are stacked and wound, the separator located between the first electrode plate and the second electrode plate;
a case configured to receive the electrode assembly; and
a cap assembly configured to seal the case,
wherein the separator comprises:
an upper separator region extending beyond a winding trailing edge of each of the first electrode plate and the second electrode plate, the upper separator region configured to wrap around an upper outermost side of the electrode assembly; and
a lower separator region extending beyond the winding trailing edge of each of the first electrode plate and the second electrode plate, the lower separator region configured to wrap around a lower outermost side of the electrode assembly, and
wherein the first substrate in electrical contact with the case in an exposed area between the upper separator region and the lower separator region.

8. The secondary battery as claimed in claim 7, wherein:
the separator comprises the exposed region provided between the upper separator region and the lower separator region, and
the first substrate is in electrical contact with the case through the exposed region.

9. The secondary battery as claimed in claim 7, wherein the upper separator region and the lower separator region are uncovered while wrapping around an outermost side of the electrode assembly for at least one turn, the outermost side comprising the upper outermost side and the lower outermost side.

10. The secondary battery as claimed in claim 7, wherein the first substrate is uncovered while wrapping around an outermost side of the electrode assembly at least one turn, the outermost side comprising the upper outermost side and the lower outermost side.

11. The secondary battery as claimed in claim 7, wherein each of a vertical width of the upper separator region and a vertical width of the lower separator region is between 5% to 40% of a total vertical width of the electrode assembly.

12. The secondary battery as claimed in claim 7, wherein a vertical width of an exposed region of the first substrate is between 60% to 95% of a total width of the electrode assembly.

13. The secondary battery as claimed in claim 7, wherein:
the upper separator region ends, moving farther away from the winding trailing edge of each of the first electrode plate and the second electrode plate, with an upper finishing tape, and
the lower separator region ends, moving farther away from the winding trailing edge of each of the first electrode plate and the second electrode plate, with a lower finishing tape.

14. The secondary battery as claimed in claim 13, wherein:
a vertical width of the upper finishing tape is less than a vertical width of the upper separator region; and
a vertical width of the lower finishing tape is less than a vertical width of the lower separator region.

15. The secondary battery as claimed in claim 13, wherein:
the upper finishing tape couples to an upper region of the first substrate through the upper separator region; and
the lower finishing tape couples to a lower region of the first substrate through the lower separator region.

16. The secondary battery as claimed in claim 7, wherein:
the first electrode plate is electrically connected to the case via a first electrode tab; and
the second electrode plate is electrically connected to the cap assembly via a second electrode tab.

17. The secondary battery as claimed in claim 16, wherein the cap assembly comprises:
an upper cap;
a safety vent coupled to the upper cap;
a lower cap which is coupled to the safety vent and to which the second electrode tab is electrically connected; and
an insulating gasket interposed between the upper cap and the safety vent, the insulating gasket in contact with an interior of the case.

18. The secondary battery as claimed in claim 16, wherein the cap assembly comprises:
a rivet terminal to which the second electrode tab is electrically connected;
an insulating gasket coupled to an outside of the rivet terminal; and
a cap plate coupled to an outside of the insulating gasket and coupled to the case.

19. The secondary battery as claimed in claim 7, wherein
the cap assembly comprises a cap plate configured to block a lower side of the case;
the secondary battery comprises a rivet terminal coupled to an upper side of the case, wherein an insulating gasket is interposed between the upper side of the case and the rivet terminal,
the first electrode plate is electrically connected to the case via a first current collecting plate, and
the second electrode plate is electrically connected to the rivet terminal via a second current collecting plate.

20. The secondary battery as claimed in claim 19, wherein the cap plate is coupled and fixed between (a) a beading portion of the case, the beading portion extending inwardly on the case, and (b) a crimping portion of the case, the crimping portion bending inwardly from the case.
